(19) United States
(12) Patent Application Publication
(10) Pub. No.: US 2010/0018914 A1
(43) Pub. Date: Jan. 28, 2010

(54) VAULT FILTER

(76) Inventor: Gary L. Koteskey, Boyne City, MI (US)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/489,941

(22) Filed: Jun. 23, 2009

Related U.S. Application Data
(60) Provisional application No. 61/083,610, filed on Jul. 25, 2008.

(51) Int. Cl. C02F 1/00; B23P 6/00; F16K 27/00

(52) U.S. Cl. 210/345; 29/402.08; 251/366

(57) ABSTRACT

A filter system includes a plurality of filter assemblies coupled to a common receiving chamber. Each filter assembly is arranged so that filtered water can flow into the receiving chamber under the influence of gravity and pressure from the difference in water level on the outside of the filter assemblies and the water level within the receiving chamber as maintained by a drain or pump within the chamber. Each filter assembly includes an upright intake tube having inlet openings spaced vertically along the intake tube. A filter housing surrounds each intake tube and is spaced from the intake tube by a distance sufficient to receive a filter element between the intake tube and the housing. A cap secures the top of the filter assembly so that all water passing into one of the inlet tube openings must have first passed through the housing and the filter element. Blocking devices are used to change one filter element while the filter system continues to operate via the other filter assemblies.

### CROSS-REFERENCE TO RELATED APPLICATIONS

The present application is related to and claims all available benefit of U.S. provisional application Ser. No. 61/083,610 filed Jul. 25, 2008.

### BACKGROUND

The present invention relates to filter assemblies useful in water discharge systems that include removable filters leading to a chamber from which filtered liquid can be pumped. The present system can be used in water collection cisterns, irrigation systems, wastewater treatment systems, or in any other fluid system where filtration is desired. The filter assemblies are useful to prevent undigested solids containing biological hazards that may be included within the solids from being inadvertently discharged from a waste water treatment facility. The undigested solids can pose substantial health threats including illnesses in humans as well as the degradation of wildlife habitat. Accordingly, most waste water regulations are drawn to inhibit or prevent the discharge of undigested solids from waste water treatment, and the present invention is intended to assist in compliance with such regulations.

Many water filter designs are known to include filter elements which are disposed within a housing. Unfiltered water enters the housing at inlet locations and must pass through the filter element to proceed to an outlet. The housing can include apertures or other inlet openings that are sized to restrict the entry of solids that are larger than the openings. In these filter designs, the apertures or inlet openings provide a first filter through which the water must pass before advancing through the filter element within the housing and proceeding to the outlet. Over time, despite the presence of the housing, the filter element generally is required to be periodically removed from the housing for cleaning or replacement to remove accumulated solids on the filter element surfaces within the housing. In many filter assembly designs, removal of the filter element for servicing leaves the outlet exposed to unfiltered or inadequately filtered water.

There are several detrimental effects caused by the passage of unfiltered or inadequately filtered water to downstream water components as well as to groundwater resources. These detrimental effects are in many cases particularly severe for wastewater filters systems that utilize a pump coupled to the outlet. In filters utilizing pumps, unfiltered wastewater or inadequately filtered wastewater passing through the filter housing would enter an outlet reservoir or pump inducer either within the housing or attached to it. These solids may plug and possibly destroy a pump once the pump is activated. Solids which do not plug the pump will be discharged to downstream wastewater system components causing contamination and degradation of the down stream water resources.

While some systems may reduce the discharge of unfiltered water or inadequately filtered water by at least temporarily stopping the pump at the outlet, many systems, such as those in use in municipal or industrial sites, have such a constant flow of wastewater that the system does not allow for stopping of the outlet pump for any significant period of time. As a consequence, there is a need for a filter system that includes easily removable filter elements that allow for the easy servicing of the water filter elements. In these water filter assemblies there is a need for ensuring that unfiltered or inadequately filtered water will not be discharged from the filter during the servicing of the filter element, particularly when the outlet pump is permitted to operate during the filter element servicing. In water filter systems utilizing pumps, there is a need to ensure that unfiltered or inadequately filtered water will not be allowed to enter a pump chamber, or will be restricted from entering the pump chamber, while the filter element is removed for servicing so that solids, which are known to damage pump components, will not be passed through to the pump. There is a particular need for a wastewater filter system that protects ground water supplies from the inadvertent discharge of undigested solids which can pose a health hazard to humans and wildlife.

### SUMMARY

These several needs may be satisfied by a filter system that includes a plurality of filter assemblies that are coupled to a common receiving chamber or vault. Each of the filter assemblies can be arranged so that filtered water can flow into the receiving chamber under the influence of gravity and any differential head pressure representing the difference in water level on the outside of the filter assemblies and the water level within the receiving chamber as maintained, for example, by a pump within the chamber. Each of the filter assemblies can take the form of an upright intake tube that can have one or more inlet openings. The inlet openings can be spaced vertically along the intake tube. A filter housing can surround each intake tube that can take the form of a mesh or screen surface to pre-filter the waste water. The housing can be spaced from the intake tube by a distance sufficient to receive a filter element between the intake tube and the housing. A cap can secure the top of the filter assembly so that all water passing into one of the inlet tube openings must have first passed through the housing and the filter element.

Replacement of a filter element can be accomplished with the aid of one or more flow blocking devices. A first flow blocking device can take the form of a rod or tube that is sized to be inserted within one of the intake tubes. One or more conformable collars can be fixed to the outside of the rod or tube, the collars being sized to contact an inner surface of the intake tube with sufficient pressure to substantially prevent any water to flow through the intake tube past the first blocking device. The first blocking device can be inserted into one of the intake tubes while the system as a whole is continuing to operate. The insertion of the first blocking device can be accomplished by removal of the cap securing the top of the filter assembly. After the first blocking device is inserted to prevent any water flow through the intake tube, the filter element surrounding the intake tube can be removed and replaced. Following replacement of the filter element, the first blocking device can be removed and the cap replaced.

A second flow blocking device can take the form of an impervious cylindrical shield dimensioned to closely surround the filter assembly housing. The second flow blocking device can have a conformable lower end ring designed to contact and seal against an edge defining the bottom end of the filter assembly housing. The second blocking device can be installed by vertically sliding the second blocking device downward over the filter assembly housing until the lower end ring seals against the bottom end of the filter assembly housing. With the second blocking device installed, the filter element between the filter assembly housing and the intake tube can be removed and replaced. The first and second blocking devices can be used individually or together to prevent any significant flow of unfiltered water into the receiving chamber. The filter in each filter assembly can be replaced in just a few minutes as compared to an hour or more for some prior art filter systems.

Each of the filter assemblies that are attached to a common receiving chamber can be sequentially replaced while the pump and the other filter assemblies continue to operate to ensure a continuous treatment of the water. The number of filter assemblies that are coupled to a common receiving chamber can vary between two and at least eight. Two or more receiving chambers can be coupled together to handle even larger flows of water. Generally, a vertical outlet pipe will be coupled to the outlet of a pump situated within the receiving chamber; however, a tube similar to a filter assembly inlet tube can be used as an outlet pipe from the pump. The pump can take the form of an open impeller pump or a turbine pump. The pump can be situated in the bottom of the receiving chamber to maximize the differential head pressure between the water outside the filter assemblies and the filtered water inside the receiving chamber. In some installations where a gravitational outlet can be provided from the central chamber, no pump is required.

The vertical height of the receiving chamber and the vertical height of the filter assemblies coupled to the receiving chamber can be varied as needed for any given installation. The base of the receiving chamber can be injection molded and shipped with other basic parts of the filter system for assembly on site. The inlet tubes and filter housings can be dimensioned to receive stock filter media having a variety of filtrations sizes ranging from 2000 micron down to 1 micron.

Other features of the present invention and the corresponding advantages of those features will be come apparent from the following discussion of the preferred embodiments of the present invention, exemplifying the best mode of practicing the present invention, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a side elevation view of a first embodiment of a vault filter assembly with one filter housing partially cut away.

FIG. 2 is a plan view of two base segments used to form the base of the assembly shown in FIG. 1.

FIG. 3 is a plan view of a base assembly including elbows.

FIG. 4 is a perspective view of two assembly bases coupled together.

FIG. 5 is a plan view of one of the bases shown in FIG. 4 including a pump support.

FIG. 6 is a side elevation view of a pump that can be supported by the pump support shown in FIG. 5.

FIG. 7 is a plan view of a guide for centering the pump outlet within the central chamber.

FIG. 8 is a side elevation view of a second embodiment of a vault filter assembly.

FIG. 9 is a side elevation view of the base of the assembly shown in FIG. 8.

FIG. 10 is a plan view of the base shown in FIG. 9.

FIG. 11 is a plan view of the vault filter assembly shown in FIG. 8.

FIG. 12 is side elevation view of the assembly shown in FIG. 8 with one filter housing removed.

FIG. 13 is a side elevation view of a first flow blocking device that can be used with the assemblies of both FIGS. 1 and 8.

### DESCRIPTION OF PREFERRED EMBODIMENTS

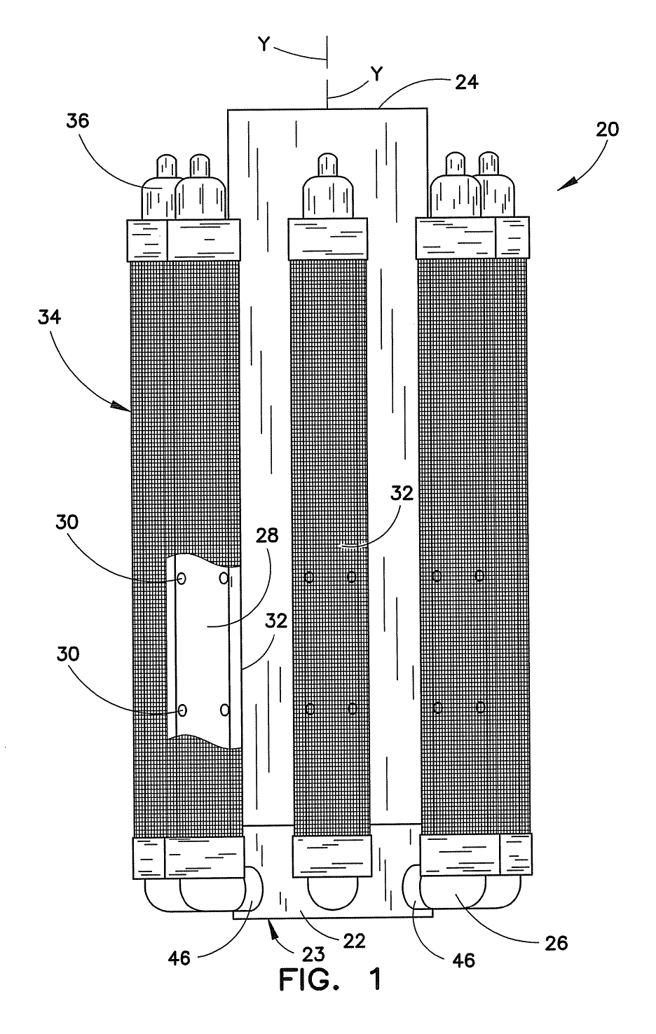

A filter system 20 is shown in FIG. 1 to include a base 22 having a lower end 23. A central chamber 24 is coupled to and extends upward from the base 22. A plurality of elbows 26 extend radially outward and upward from the base 22. An intake tube 28 is coupled to and supported by each elbow 26. Each intake tube 28 includes a plurality of inlet openings 30 spaced vertically along the length of tube 28. A filter housing 32 surrounds each intake tube 28. A filter element, not shown, can be situated between the intake tube 28 and the filter housing 32. The filter housing 32 can take the form shown in my U.S. Design Pat. D571,433. By way of example only, the filter element can take the form of a polymer foam filter, a pleated filter, or a sock filter. The intake tube 28, filter housing 32, and filter element together form a filter assembly 34. A cap 36 is situated at the top of each filter assembly 34 so that any water surrounding the filter system 20 must pass through the filter housing 32 and filter before entering the intake tube 28 and central chamber 24.

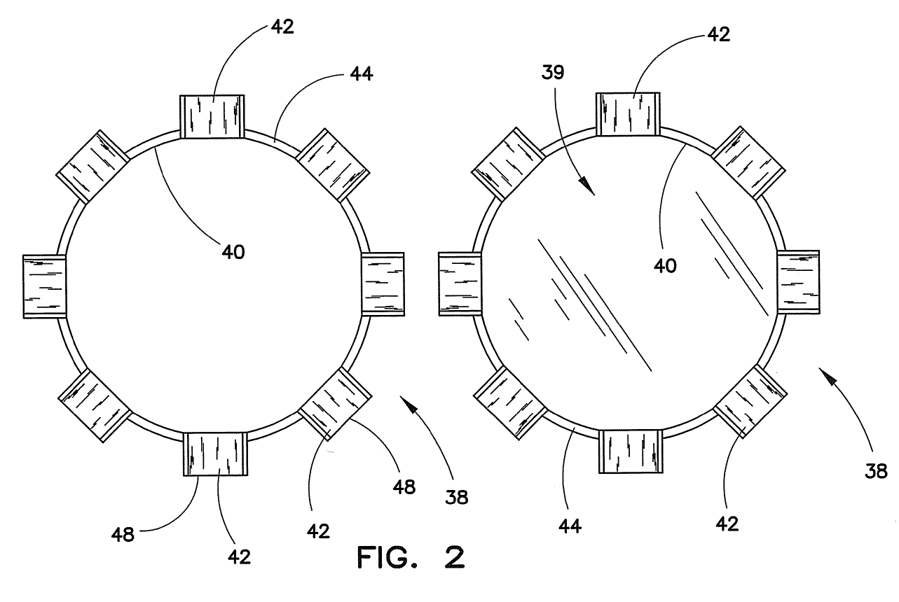

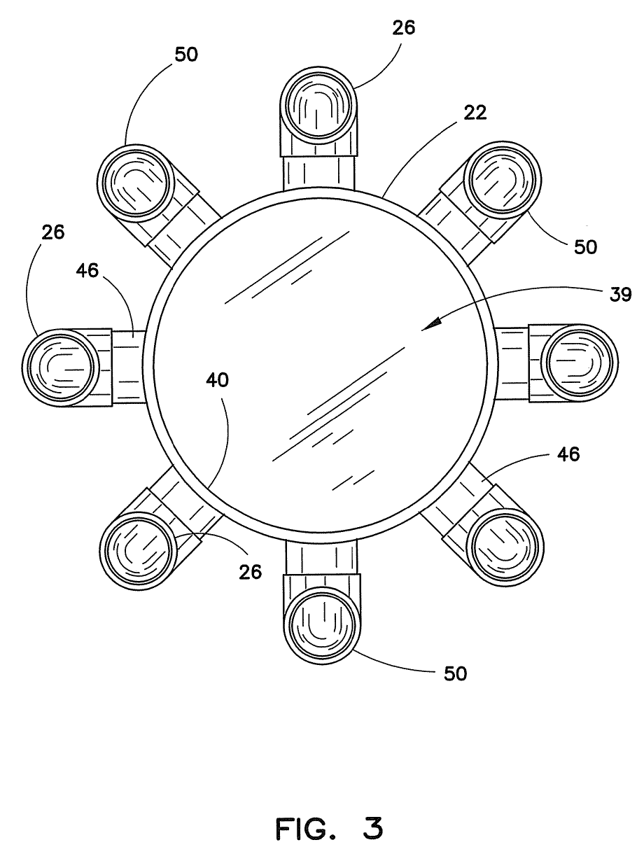

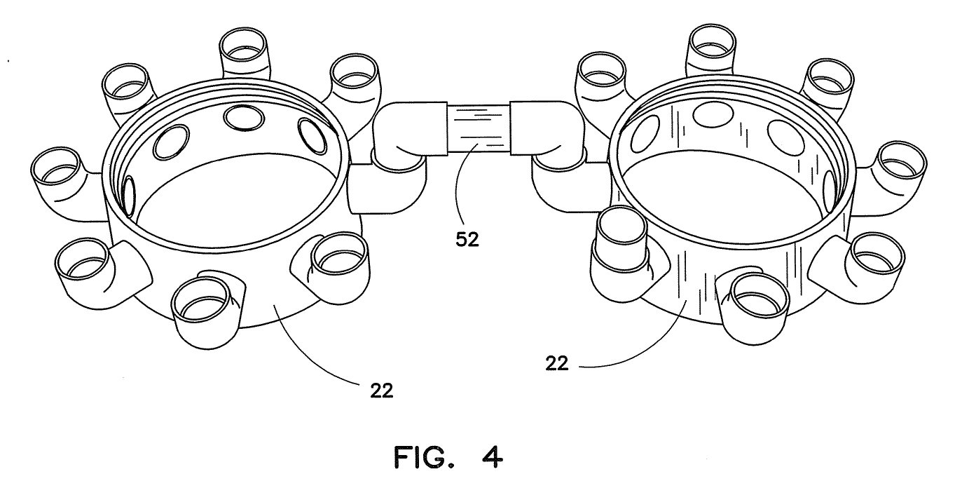

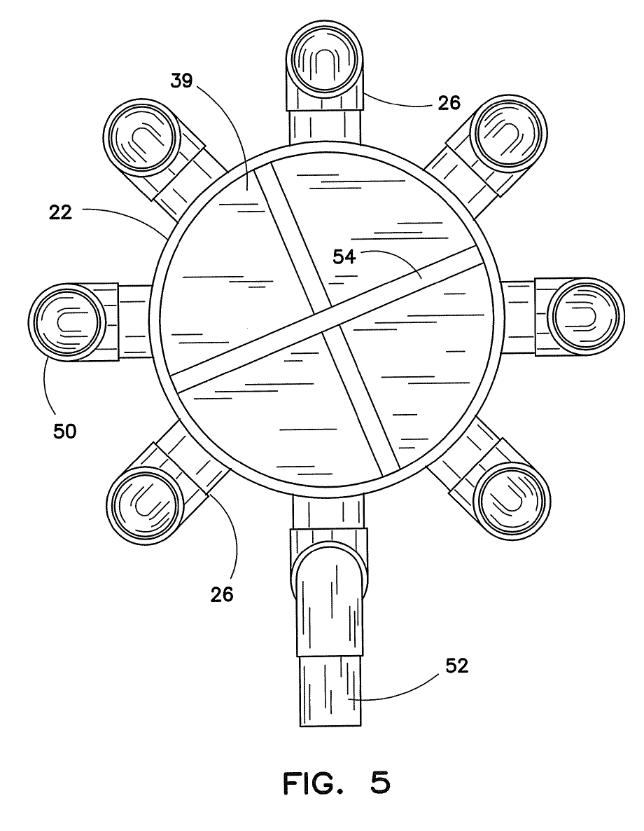

The base 22 can be formed from the assembly of two base portions 38, as shown in FIG. 2. Each base portion 38 is shown to have a side wall 40, a plurality of radially extending half cylinders 42 and a joining surface 44. Each base portion 38 can be assembled from individual elements that are bonded together using a suitable cement, or can be injection molded as a unitary, one piece unit. One of the base portions 38 can include a bottom plate 39 closing the lower end 23 of the base 22. The joining surfaces 44 of two base portions 38 can be bonded together to form the base 22 as shown in FIGS. 1 and 3, the half cylinders 42 forming radially extending sleeves 46 shown in FIG. 1. The elbows 26 can be fixed to an outer end 48 of each of the sleeves 46 so that an outer portion 50 of all of the elbows are aligned substantially parallel to a vertical axis Y of the central chamber 24 shown in FIG. 1. Two or more bases 22 can be joined together by a fluid coupling member 52 as shown, for example, in FIG. 4 to form a filter system 20 having a larger volume and flow capacity. A pump support 54 can be included in the base 22 as shown, for example, in FIG. 5.

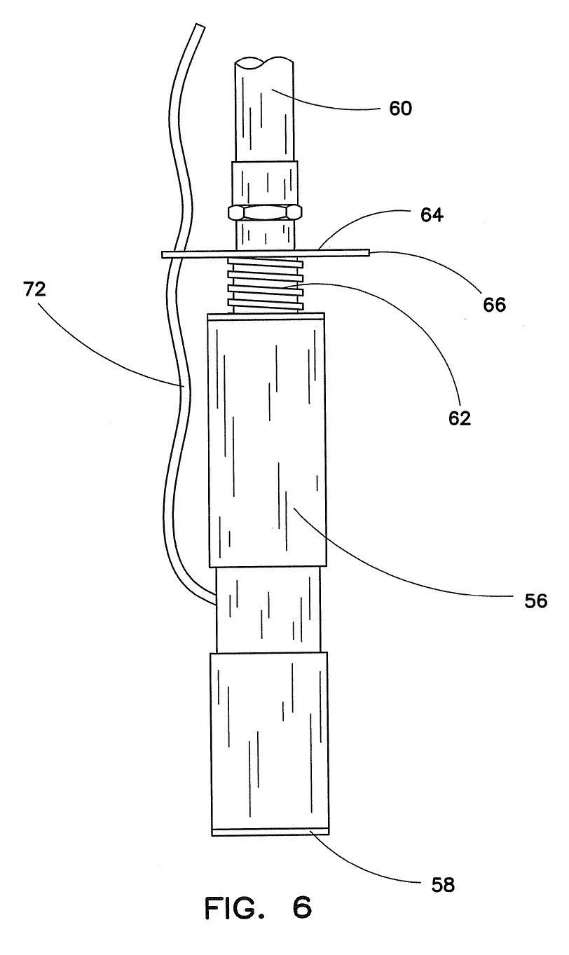

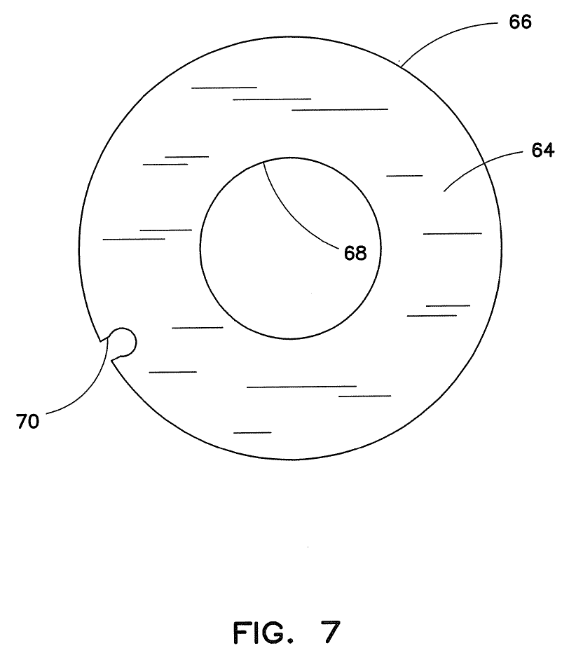

A pump 56, such as that shown in FIG. 6, can be positioned within the central chamber 24 so that a lower end 58 of the pump 56 is supported by pump support 54. An upwardly directed outlet pipe 60 is coupled to an upper end 62 of the pump 56. The outlet pipe 60 can be surrounded by a collar 64 having a radially outer edge 66 that can be sized to be in contact or in close proximity with an inner surface of the central chamber 24 so as to further support the pump 56 in an upright position within the central chamber 24. The collar 64 is also shown in FIG. 7 to include a central opening 68 intended to receive the outlet pipe 60 and an edge opening 70 suitable for receiving the power cable 72 that provides power to pump 56.

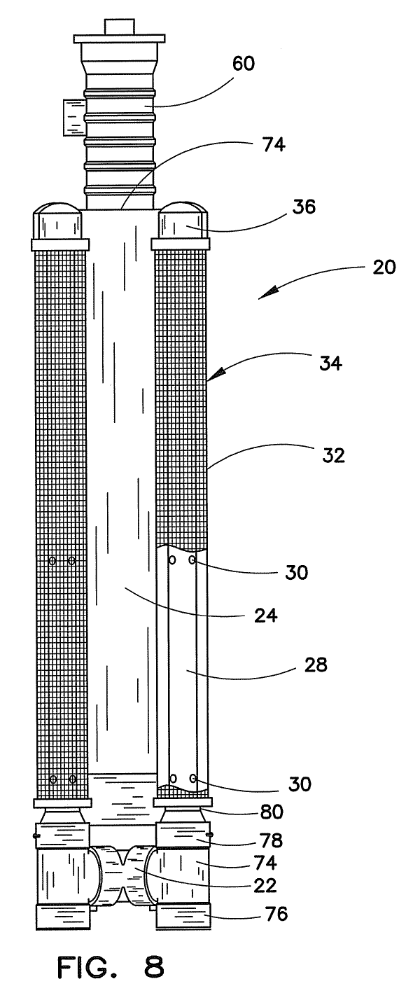

A second filter system 20 is shown in FIG. 8 to include a base 22. A central chamber 24 is coupled to and extends upward from the base 22. A plurality of T-members 74 extend radially outward from the base 22. A lower end 76 of each of the T-members 74 is closed while an upper end 78 is open and joined to a coupling element 80. The coupling element 80 couples an intake tube 28 to each T-member 74. As in the first filter system 20, each intake tube 28 includes a plurality of inlet openings 30 spaced vertically along the length of tube 28. A filter housing 32 surrounds each intake tube 28. A filter element, not shown, can be situated between the intake tube 28 and the filter housing 32. By way of example only, the filter element can again take the form of a polymer foam filter, a pleated filter, or a sock filter. The intake tube 28, filter housing 32, and filter element together form a filter assembly 34. A cap 36 is situated at the top of each filter assembly 34 so that any water surrounding the filter system 20 must pass through the filter housing 32 and filter before entering the intake tube 28 and central chamber 24. An outlet 60 is shown protruding from an upper end 74 of the central chamber 24.

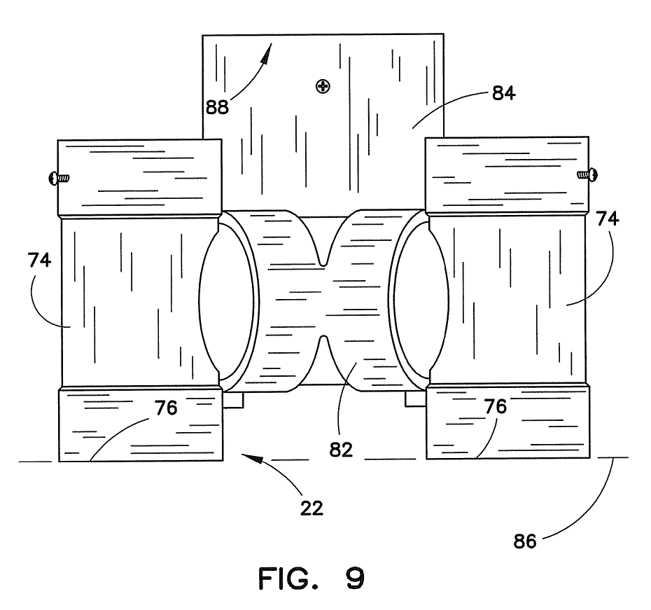

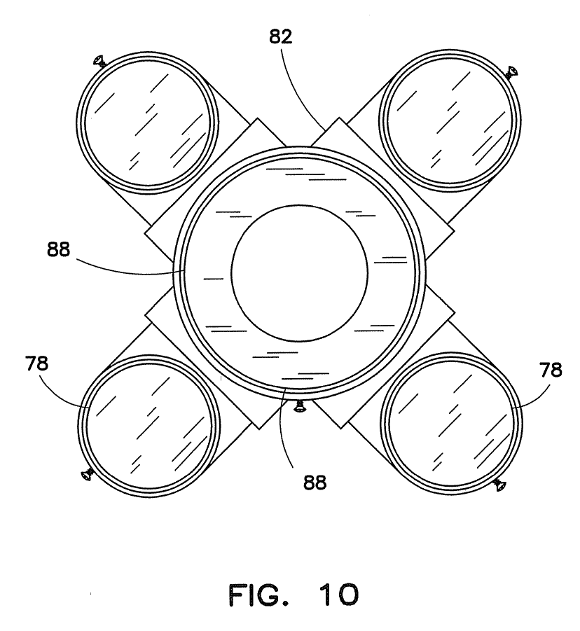

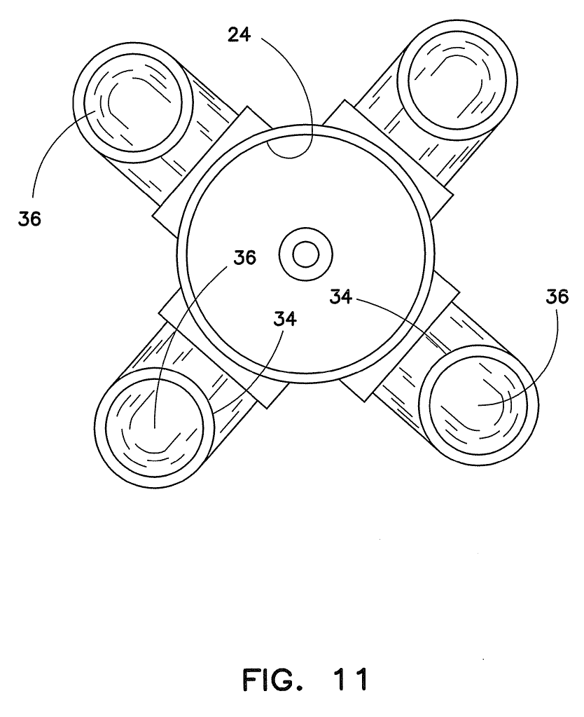

The base 22 of the second assembly 20 is shown in detail in FIGS. 9 and 10. The base 22 of the second assembly 20 includes a four-way junction member 82 having an upper opening 84. Four T-members 74 are fixed to the four way junction member 82 so that the lower ends 76 of the T-members 74 lie in a common plane 86 defining a supporting surface for the base 22. An upper end 88 of the upper opening 84 is adapted to receive the central chamber 24 while an upper end 78 of each of the four T-members 74 is adapted to receive a coupling element 80, previously described. The interior of the central chamber 24 can be seen in FIG. 11, which also shows a close-up view of the caps 36 located at the top of the filter assemblies 34 that are positioned around the central chamber 24.

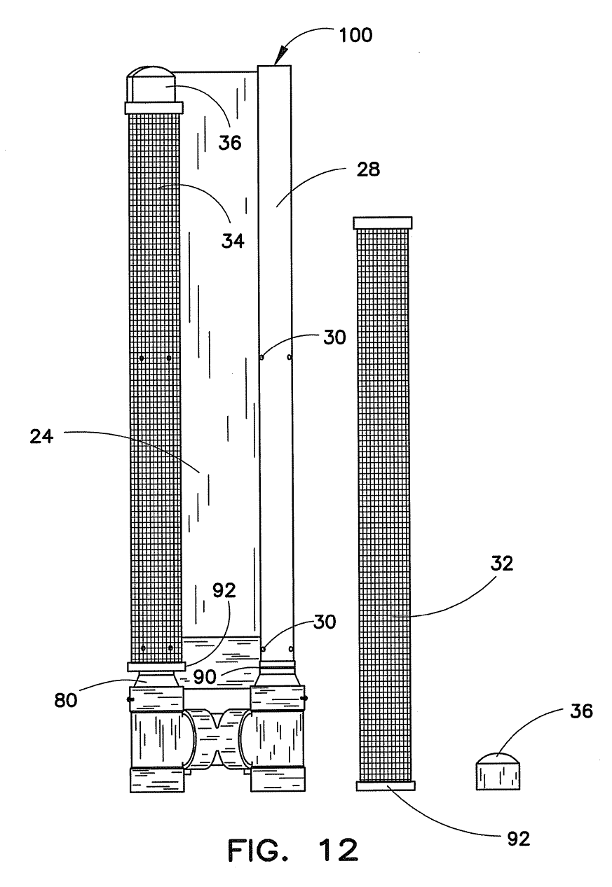

FIG. 12 shows the second filter system 20 with one of the filter housings 32 removed to reveal the intake tube 28 which includes a plurality of inlet openings 30 spaced vertically along the length of tube 28. The filter housing 32 can take the form shown in my U.S. Design Pat. D571,433. Other designs for the filter housing 32 are possible that will provide larger or smaller spacing between the filter housing 32 and intake tube 28 to provide best suitability for a selected filter, not shown. A seal 90 can be provided at the lower end of the intake tube 28 to seal against the interior lower end 92 of the filter housing, to prevent water from passing around the filter assembly 34. The open upper end 100 of the intake tube 28 can be closed and sealed by a cap 36.

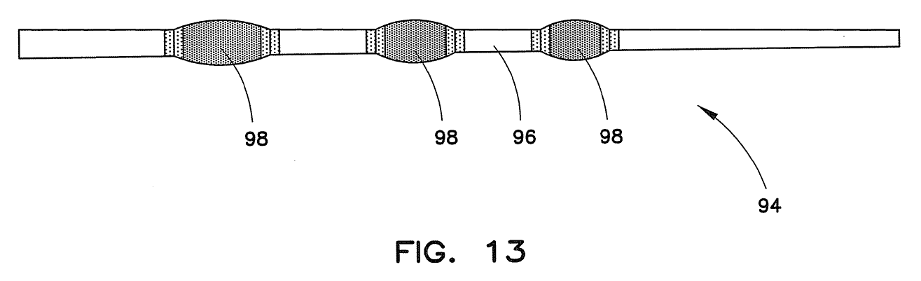

FIG. 13 shows a first flow blocking device 94. The first blocking device can take the form of a rod or tube 96 that is sized to be inserted within one of the intake tubes 28. One or more conformable collars 98 can be fixed to the outside of the rod or tube 96. The collars 98 can be sized to contact an inner surface of the intake tube 28 with sufficient pressure to substantially prevent any water to flow through the intake tube 28 past the first blocking device 94. The first blocking device 94 can be inserted into one of the intake tubes 28 while the system 20 as a whole is continuing to operate. The insertion of the first blocking device 94 can be accomplished by removal of the cap 36 securing the top of the filter assembly 34 and inserting the first blocking device 94 into the open upper end 100 of the intake tube 28. After the first blocking device is inserted into the intake tube 28 to the necessary depth to prevent any water flow through the intake tube, the filter element surrounding the intake tube can be removed and replaced. Following replacement of the filter element, the first blocking device 94 can be removed and the cap 36 replaced.

A second flow blocking device, not shown, can take the form of an impervious cylindrical shield dimensioned to surround the filter assembly housing 32. The second flow blocking device can have a conformable lower end ring designed to contact and seal against coupling element 80 or another edge defining the bottom end 92 of the filter assembly housing 32. The second blocking device can be installed by vertically sliding the second blocking device downward over the filter assembly housing 32 until the lower end ring seals against the coupling element 80 or bottom end 92 of the filter assembly housing 32. With the second blocking device installed, the filter element between the filter assembly housing 32 and the intake tube 28 can be removed and replaced. The first and second blocking devices can be used individually or together to prevent any significant flow of unfiltered water into the receiving chamber 24. The filter in each filter assembly can be replaced in just a few minutes as compared to an hour or more for some prior art filter systems.

While these features have been disclosed in connection with the illustrated preferred embodiments, other embodiments of the invention will be apparent to those skilled in the art that come within the spirit of the invention as defined in the following claims.

What is claimed is:

1. A filter system comprising: a receiving chamber for receiving filtered liquid, a plurality of filter assemblies coupled to the receiving chamber, each filter assembly including an upright intake tube having a plurality of openings spaced vertically along the intake tube, a filter housing surrounding the upright intake tube at a substantially uniform spacing from the intake tube, a filter element situated between the filter housing and the intake tube, and a cap securing an upper end of the filter housing and filter element to the intake tube so that all water passing into any one of the plurality of openings of the intake tube must have first passed through the filter housing and filter element.

2. The filter system of claim 1, further comprising a base coupled to a lower portion of the receiving chamber, and an outwardly extending elbow coupled between the base and the upright intake tube of each of the filter assemblies.

3. The filter system of claim 1, further comprising a pump support situated with the receiving chamber, and a pump positioned with the central chamber having an outlet pipe extending upwardly from an outlet of the pump.

4. The filter system of claim 3, further comprising a collar having an inner edge surrounding the outlet pipe and an outer edge in close proximity with an inner surface of the receiving chamber.

5. The filter system of claim 1, further comprising a base coupled to a lower portion of the receiving chamber, and an outwardly extending T-member coupled to the base and having an upwardly extending portion of the T-member coupled to the upright intake tube of each of the filter assemblies, and a cap closing a downwardly extending portion of the T-member.

6. The filter system of claim 5, wherein the base further comprises a multi-way junction member having an upward opening coupled to the receiving chamber and a plurality of lateral openings coupled to a plurality of the outwardly extending T-members so that the caps closing the downwardly extending portions of the T-members lie in a common plane.

7. A blocking device for blocking the flow of filtered water from an intake tube having a plurality of vertically spaced inlets into a collection chamber comprising: an elongated member having a cross section sized to be inserted within the intake tube, at least one conformable collar fixed to an outside surface of the elongated member, each conformable collar having an outside surface sized to contact an inner surface of the intake tube with sufficient pressure to substantially prevent any water to flow through the intake tube.

8. A blocking device for blocking the flow of filtered water from an intake tube having a plurality of vertically spaced inlets into a collection chamber comprising: an elongated member having a cross section sized to telescopically surround the intake tube, at least one conformable collar fixed to an inside surface of the elongated member, each conformable collar having an inside surface sized to contact an outer surface of the intake tube with sufficient pressure to substantially prevent any water to flow through the intake tube.

9. A method of replacing a filter element in a filter assembly, the assembly including a receiving chamber for receiving filtered liquid, a plurality of filter assemblies coupled to the receiving chamber, each filter assembly including an upright intake tube having a plurality of openings spaced vertically along the intake tube, a filter housing surrounding the upright intake tube at a substantially uniform spacing from the intake tube, and a filter element situated between the filter housing and the intake tube, and a cap securing an upper end of the filter housing and filter element to the intake tube, the method comprising the steps of:
removing the cap from one of the filter assemblies,
inserting a blocking device into the interior of the intake tube, the blocking device including at least one conformable collar fixed to an outside surface of the elongated member, each conformable collar having an outside surface sized to contact an inner surface of the intake tube with sufficient pressure to substantially prevent any water to flow through the intake tube,
sliding the filter element upward and out from between the filter housing and the intake tube,
inserting a replacement filter element between the filter housing and the intake tube,
removing the blocking device and replacing the cap to secure the upper end of the filter housing and replacement filter element to the intake tube.

10. A method of replacing a filter element in a filter assembly, the assembly including a receiving chamber for receiving filtered liquid, a plurality of filter assemblies coupled to the receiving chamber, each filter assembly including an upright intake tube having a plurality of openings spaced vertically along the intake tube, a filter housing surrounding the upright intake tube at a substantially uniform spacing from the intake tube, and a filter element situated between the filter housing and the intake tube, and a cap securing an upper end of the filter housing and filter element to the intake tube, the method comprising the steps of:
removing the cap from one of the filter assemblies,
inserting a blocking device inside the filter element contiguously onto the exterior of the intake tube, the blocking device including at least one conformable collar fixed to an inside surface of the blocking device, each conformable collar having an inside surface sized to contact an outer surface of the intake tube with sufficient pressure to substantially prevent any water to flow into the intake tube,
sliding the filter element upward and out from between the filter housing and the blocking device,
inserting a replacement filter element between the filter housing and the blocking device,
removing the blocking device and replacing the cap to secure the upper end of the filter housing and replacement filter element to the intake tube.
